(19) United States
(12) Patent Application Publication
(10) Pub. No.: US 2024/0193016 A1
(43) Pub. Date: Jun. 13, 2024

(54) MULTIPLE PROCESSES SHARING GPU MEMORY OBJECTS

(71) Applicants: Advanced Micro Devices, Inc., Santa Clara, CA (US); ATI Technologies ULC, Markham (CA)

(72) Inventors: AnZhong Huang, Shanghai (CN); Zhengsan Jian, Shanghai (CN); Yinan Jiang, Markham (CA)

(21) Appl. No.: 18/064,170

(22) Filed: Dec. 9, 2022

(51) Int. Cl. G06F 9/54; G06F 12/02

(52) U.S. Cl. CPC G06F 9/544; G06F 12/023

(57) ABSTRACT

An apparatus and method for efficiently executing multiple processes by reducing an amount of memory usage of the processes. In various implementations, a computing system includes a first processor and a second processor that support parallel data applications stored on a remote server that provides cloud computing services to multiple users. The first processor creates multiple processes, referred to as “instances” in parallel computing platforms, for a particular application as users request to execute the application. When the first processor detects a function call of the application within a particular instance, the first processor searches for shareable data objects to be used by the second processor when executing the first instance of the function call, and frees data storage allocated to data objects that are already shared by one or more instances. Therefore, an amount of memory allocated for the multiple instances of the application is reduced.

### BACKGROUND

### Description of the Relevant Art

The parallelization of tasks is used to increase the throughput of computing systems. To this end, compilers extract parallelized tasks from program code to execute in parallel on the system hardware. Processor cores include deep pipelines configured to perform multi-threading. To further increase parallel execution on the hardware, a multi-core architecture includes multiple processor cores. The computing system offloads specific tasks to special-purpose hardware, which overcomes the performance limitations of conventional general-purpose cores. Some types of the special-purpose hardware include a single instruction multiple data (SIMD) parallel architecture, other types include a field-programmable gate array (FPGA), and yet other types include other specialized types of processing cores. When an architecture includes multiple cores of different types it is referred to as a heterogeneous multi-core architecture. Heterogeneous multi-core architectures provide higher instruction throughput than a homogeneous multi-core architecture for particular tasks such as graphics rendering, neural network training, cryptography and so forth.

Designers use one of multiple types of parallel computing platforms and application programming interface (API) models for developing applications for heterogeneous computing. A function call in these platforms is referred to as a “compute kernel”, or simply a “kernel”. When executing instructions of an operating system scheduler, a general-purpose processor matches these software kernels with one or more records of data, such as data items, to produce one or more work units of computation.

Generally speaking, a single-instruction-multiple-data (SIMD) architecture offers good computing performance and cost efficiency when executing such data parallel workloads. However, performance reduces when an amount of memory is insufficient to store the data requested by the application. For example, the general-purpose processor creates multiple processes, referred to as “instances” in the parallel computing platforms, for a particular application. Each instance uses the same data, but each instance has its own copy. Either a number of instances supported by the SIMD processor is limited, or performance for the instances reduce as the instances generate multiple memory access requests to retrieve needed data to store in a region of local memory associated with a limited address space.

In view of the above, methods and systems for efficient execution of multiple processes by reducing an amount of memory usage of the processes are desired.

### BRIEF DESCRIPTION OF THE DRAWINGS

FIG. 1 is a generalized block diagram of computing system.

FIG. 2 is a generalized block diagram of a model of multiple levels of a computing system.

FIG. 3 is a generalized block diagram of a model of multiple levels of a computing system.

FIG. 4 is a generalized block diagram of a method for efficient execution of multiple processes by reducing an amount of memory usage of the processes.

FIG. 5 is a generalized block diagram of a method for determining conditions are satisfied to search for shareable data used by multiple instances of a particular application.

FIG. 6 is a generalized block diagram of a method for searching for shareable data used by multiple instances of a particular application.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently executing multiple processes by reducing an amount of memory usage of the processes are contemplated. In various implementations, a computing system includes memory for storing an operating system, software applications developed by designers, and both user data and result data of the software applications. The computing system also includes a first processor and a second processor. In various implementations, the first processor is a general-purpose processor with one or more processor cores with circuitry capable of executing instructions of a general-purpose instruction set architecture (ISA), and the second processor includes one or more processor cores with circuitry that supports a single instruction multiple data (SIMD) parallel architecture. In an implementation, an accelerated processing unit (APU) on a motherboard includes the first processor and the second processor. In another implementation, the first processor is in a package on the motherboard, and one or more slots (sockets) on the motherboard include a video graphics card with the second processor.

One or more of the applications include instructions that support parallel data algorithms. For example, an application includes algorithms for a graphics shader program that directs how the second processor renders pixels for controlling lighting and shading effects. In addition, the application includes pixel interpolation algorithms for geometric transformations. Pixel interpolation obtains new pixel values at arbitrary coordinates from existing data. In some implementations, the application is a requested application that is a particular video game application accessed through the Internet. In other implementations, the application is a requested application that is another type of application that supports parallel data algorithms accessed through the Internet. In such implementations, the first processor and the second processor are used within a remote server computer (or remote server) that provides cloud computing services to multiple users.

The first processor creates multiple processes, referred to as “instances” in parallel computing platforms, for a particular application. The first processor creates each of these multiple processes when users request to execute the application. For example, a user computing device received user input to begin using the application, and the user computing device sent a user request across a network, such as the Internet, to the first processor of the remote server. The first processor translates instructions of parallel data function calls of the application to commands that are executable by the second processor. In various implementations, when the first processor detects a function call of the application within a particular instance of the multiple instances, the first processor searches for shareable data objects to be used by the second processor when executing the first instance of the function call. The data object can be a particular data object reused in the application multiple times such as a character or portion of a scene in a cloud computing video game application.

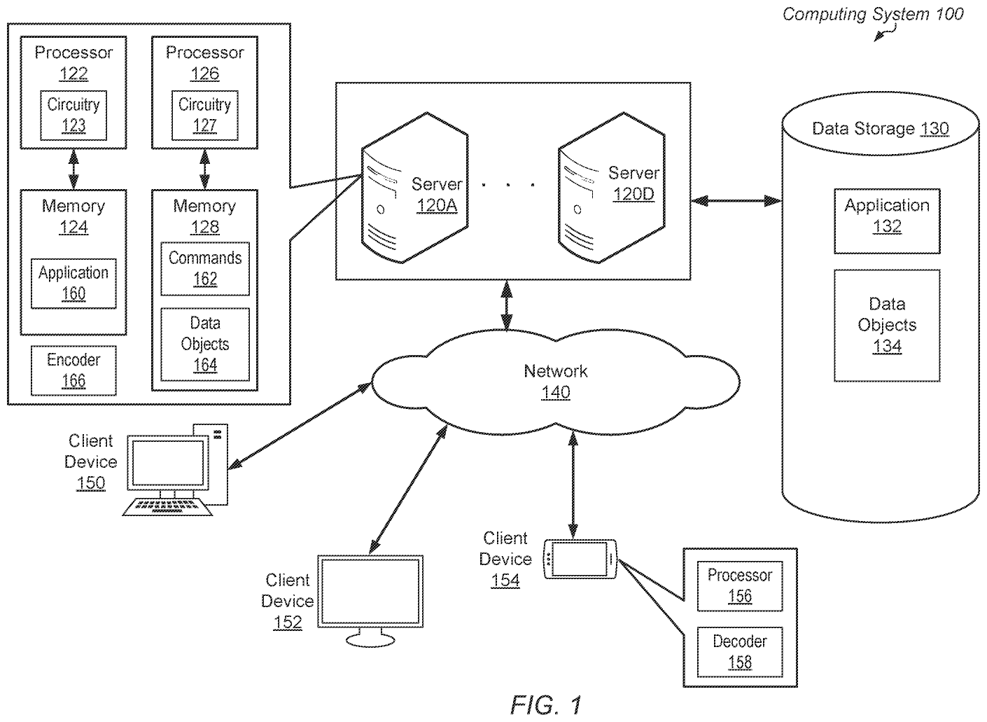

In an implementation, the first processor qualifies performing the search based on multiple conditions. A first condition is the first processor determines the function call is a particular type of function call such as a graphics function call or other type of parallel data function call. A second condition is the first processor determines a particular data object used by the function call is a non-writeable data object. A third condition is the first processor determines a size of the particular data object used by the function call is greater than a size threshold. The first processor frees data storage allocated for the particular instance to be used for storing the particular data object when the first processor determines the particular data object is already shared by one or more instances of the multiple instances of the application being executed by the second processor. The first processor maintains data storage allocated for the particular instance to be used for storing the particular data object when the first processor determines the particular data object is not already shared by one or more instances of the plurality of instances of the application being executed by the second processor. Therefore, an amount of memory allocated for the multiple instances of the application being executed by the second processor is reduced. This data storage reduction in the memory improves system performance. Further details are provided in the following description of FIGS. 1-6.

Turning now to FIG. 1, a generalized diagram is shown of a computing system 100. In the illustrated implementation, the computing system 100 includes multiple client devices 150, 152 and 154, a network 140, the servers 120A-120D, and the data storage 130 that includes a copy of an application 132 and multiple data objects 134. As shown, the server 120A includes a processor 122 that accesses the memory 124 to process tasks, and the processor 126 that accesses the memory 128 to process tasks. When processing tasks, each of the processors 122 and 126 is capable of executing particular instructions or commands, generating memory access requests, generating messages for a particular destination, generating tasks for the other processor to execute, and so forth. The data storage 130 includes one or more of a variety of hard disk drives and solid-state drives for data storage. It is noted that in other implementations, the data stored on the data storage 130, such as at least the application 132 and the multiple data objects 134, are stored on a memory device of one or more of the servers 120A-120D. Although three client devices 150, 152 and 154 are shown, any number of client devices are capable of accessing the application 160 stored in memory 124 on server 120A, which is a copy of the application 132 stored in the data storage 130 (or stored in a memory device of one of the servers 120A-120D). As further described later, when any of the client devices 150, 152 and 154 accesses the application 160, an instance of the application 160 is created and stored in memory 124.

As shown, the client device 154 includes hardware, such as circuitry, of a processor 156 and a decoder 158. The processor 156 executes instructions of computer programs. The decoder 158 decodes encoded video frame information received from one or more of the servers 120A-120D via the network 140. The client devices 150 and 152 also include circuitry similar to the processor 156 and the decoder 158 of the client device 154. Examples of the client devices 150, 152 and 154 are a laptop computer, a smartphone, a gaming console connected to a television, a tablet computer, a desktop computer, or other.

Clock sources, such as phase lock loops (PLLs), an interrupt controller, a communication fabric, power controllers, memory controllers, interfaces for input/output (I/O) devices, and so forth are not shown in the computing system 100 for ease of illustration. It is also noted that the number of components of the computing system 100 and the number of subcomponents for those shown in FIG. 1, such as within the servers 120A-120D and the client devices 150, 152 and 154, can vary from implementation to implementation. There can be more or fewer of each component/subcomponent than the number shown for the computing system 100.

In some implementations, the client devices 150, 152 and 154 include a network interface (not shown) supporting one or more communication protocols for data and message transfers through the network 140. The network 140 includes multiple switches, routers, cables, wireless transmitters, and the Internet for transferring messages and data. Accordingly, the network interface of the client device 150 support at least the Hypertext Transfer Protocol (HTTP) for communication across the World Wide Web. In some implementations, an organizational center (not shown) maintains the application 132. In addition to communicating with the client devices 150, 152 and 154 through the network 140, the organizational center also communicates with the data storage 130 for storing and retrieving data. Through user authentication, users are able to access resources through the organizational center to update user profile information, access a history of purchases or other accessed content, and download content for purchase.

In various implementations, the processor 122 is a general-purpose processor, and the hardware, such as circuitry 123, of the processor 122 includes one or more processor cores with circuitry capable of executing instructions of a general-purpose instruction set architecture (ISA). In various implementations, the hardware, such as circuitry 127, of the processor 126 includes one or more processor cores with circuitry that supports a single instruction multiple data (SIMD) parallel architecture. In some implementations, the processor 122 is a general-purpose central processing unit (CPU), and the processor 126 is one of a variety of types of an application specific integrated circuit (ASIC), a digital signal processor (DSP), a field programmable gate array (FPGA), a graphics processing unit (GPU), and so forth.

The processor 122 uses the memory 124 as a system memory, and accesses the memory 124 while processing tasks. In some implementations, the memory 124 is one of a variety of types of synchronous random-access memory (SRAM). In an implementation, the processor 122 and the memory 124 include circuitry of memory controllers that support one of a variety of types of a Double Data Rate (DDR) communication protocol or one of a variety of types of a Low-Power Double Data Rate (LPDDR) communication protocol.

The processor 126 uses the memory 128 as a local memory such as a local data store or a local buffer, and accesses the memory 128 while processing tasks. In some implementations, the memory 128 is one of a variety of types of SRAM. In an implementation, the processor 126 and the memory 128 include circuitry of memory controllers that support one of a variety of types of a Graphics Double Data Rate (GDDR) communication protocol. In an implementation, one or more of the memory 124 and the memory 128 are memory devices separate from and located externally from a corresponding one of the processors 122 and 126. The memory devices include circuitry for storing data such as circuitry that provides one of the variety of types of SRAM. In another implementation, one or more of the memory 124 and the memory 128 are included within a corresponding one of the processors 122 and 126. The circuitry of a corresponding one of the processors 122 and 126 includes circuitry that provides one of the variety of types of SRAM.

In an implementation, an accelerated processing unit (APU) on a motherboard of the server 120A includes the processor 122 and the processor 126. In another implementation, the processor 122 is in a package on the motherboard, and one or more slots (sockets) on the motherboard include a video graphics card with the processor 126. Therefore, although a single processor 126 connected to a corresponding memory 128 is shown, it is possible and contemplated that the server 120A includes multiple SIMD processors, each connected to a different memory.

The servers 120A-120D include a variety of server types such as database servers, computing servers, application servers, file servers, mail servers and so on. In various implementations, the servers 120A-120D and the client devices 150, 152 and 154 operate with a client-server architectural model. In various implementations, the application 132 is one of a variety of types of parallel data applications. The application 132 includes instructions that support parallel data algorithms. In an implementation, the application 132 includes algorithms for a graphics shader program that directs how the processor renders pixels for controlling lighting and shading effects. In addition, the application 132 can also include pixel interpolation algorithms for geometric transformations. Pixel interpolation obtains new pixel values at arbitrary coordinates from existing data. In another implementation, the application 132 includes algorithms used for the training of deep neural networks (DNNs) and other types of neural networks. In yet other implementations, the application 132 includes instructions for directing a SIMD core to perform General Matrix to Matrix Multiplication (GEMM) operations or other parallel data operations for other scientific and business uses.

In some implementations, the application 132 is a user-requested application that is a particular video game application accessed through the network 140. In other implementations, the application 132 is a requested application that is another type of application that supports parallel data algorithms accessed through the network 140. In such implementations, the server 120A is one or one or more remote servers that provide cloud computing services to multiple users. For example, one of the client devices (or client computing devices or user devices or user computing devices) 150, 152 and 154 receives user input to begin using the application 132, and in response, sends a user request across the network 140 to the processor 122 of the server 120A.

The processor 122 creates multiple processes, referred to as “instances” in parallel computing platforms, for the application 160, which is a copy of the application 132. When creating the instance, the processor 122 relies on information such as at least identification of the application 160, identification of a version of the application 160, and identification of targeted hardware to run the application such as the processor 126. Creating the instance links the instructions of the application 160 to the parallel computing framework library used to define a parallel data application programming interface (API) model. Other information of the created instance is similar to an operating system process state information. Therefore, each instance of the application 160 has its own resources separate from any other instance of the same application 160 running on the same hardware such as processor 126.

The processor 122 creates each of these multiple instances when users request to execute the application 160. For each of the instances, the processor 122 translates instructions of parallel data function calls of the application 160 to commands 162 that are executable by the processor 126. The processor 122 stores the commands in a ring buffer (not shown), and notifies the processor 126. The processor 126 retrieves a copy of the commands 162 and executes the commands. Each of the processor 122 and the processor 126 includes circuitry of input/output (I/O) interface controllers that support a communication protocol such as the Peripheral Component Interconnect Express (PCIe) protocol. The processors 122 and 126 use these I/O interfaces to communicate with one another.

As used herein, the term “data object” refers to a data structure that stores data of a common type and is accessible via a unique identifier. Examples of the data objects 134 are a character of a video game, a portion of the character or a portion of a scene of the video game, and so on. In various implementations, the data objects 134 are used in the application 132 (and its copy, which is application 160), and the application 132 is a cloud computing video game application. In various implementations, the processor 126 performs at least rendering operations on the data objects 134 based on user inputs received from a corresponding one of the client devices 150, 152 and 154. One or more of the data objects 134 are included in one or more video frames.

The server 120A includes circuitry of an encoder 166 that encodes the rendered frames, and then the server 120A sends the encoded frame information to the corresponding one of the client devices 150, 152 and 154 through the network 140. As described earlier, the client devices 150, 152 and 154 include a decoder, such as the decoder 158 of the client device 154, for decoding the received encoded versions of the rendered frames. After decoding, the circuitry of the client devices 150, 152 and 154 send the decoded frames to a corresponding display controller for displaying the corresponding data objects on a monitor or screen. For other parallel data applications, the client devices 150, 152 and 154 perform other operations with other types of result data provided by the processor 126 of the server 120A. However, the number of instances increases as the number of users who wish to run the application 160 increases, the amount of available data storage in memory 128 reduces. Eventually, either a number of instances supported by the processor 126 is limited, or performance for the instances reduce as the instances generate multiple memory access requests to retrieve needed data objects of the data objects 134 to store in a region of memory 128 associated with a limited address space of a particular instance.

To avoid the above performance bottleneck, in various implementations, when the processor 122 detects a function call of the application 160 with parallel data operations within a particular instance of the multiple instances, the processor 122 searches for shareable data objects to be used by the processor 126 when executing the particular instance of the function call. The data object can be one of the multiple data objects 134 used in the application 160. In an implementation, the processor 122 qualifies performing the search based on multiple conditions. A first condition is the processor 122 determines the function call is a particular type of function call such as a graphics function call or other type of parallel data function call. A second condition is the processor 122 determines a particular data object used by the function call is a non-writeable data object. A third condition is the processor 122 determines a size of the particular data object used by the function call is greater than a size threshold.

The processor 122 frees data storage allocated for the particular instance to be used for storing the particular data object when the processor 122 determines the particular data object is already shared by one or more instances of the multiple instances of the application being executed by the processor 126. The processor 122 maintains another data storage, which is implemented as a list or a table, allocated for the particular instance to be used for storing the particular data object when the processor 122 determines the particular data object is not already shared by one or more instances of the plurality of instances of the application being executed by the processor 126. Therefore, an amount of data storage in memory 128 allocated for storing data objects 164 for the multiple instances of the application 160 being executed by the processor 126 is reduced. The data objects 164 are copies of a subset of the data objects 134. In implementations where the application is a graphics application, the amount of data storage in memory 128 used for frame buffers is reduced. This data storage reduction in the memory 128 improves system performance.

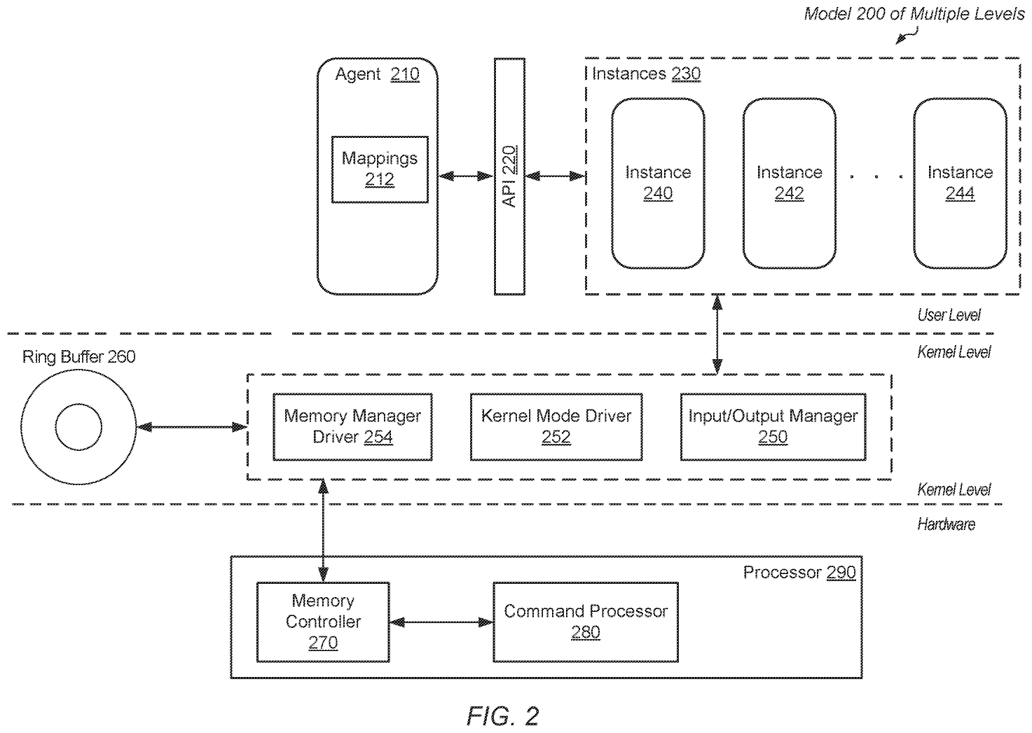

Turning now to FIG. 2, a generalized diagram is shown of a model 200 of multiple levels of a computing system. As shown, model 200 uses a collection of user mode components, kernel mode components, and hardware. A layered component model, such as model 200, is one manner to process parallel data applications. The user level (or user mode) components include the agent 210, the application programming interface (API) 220, and the instances 230. As shown, the instances 230 include the individual instances 240, 242, and 244. Although three instances are shown, in various implementations, any number of simultaneously executing instances is possible and contemplated. The kernel level (or kernel mode) includes the input/output (I/O) manager 250, the kernel mode driver 252, and the memory manager driver 254, and the ring buffer 260.

As shown, the hardware level includes the circuitry of a processor 290. In some implementations, the processor 290 is one of a variety of types of a parallel data processor (or data-parallel processor). As shown, the processor 290 includes at least the circuitry of the memory controller 270, and the circuitry of the command processor 280, which is used within parallel data processors. In various implementations, the instructions of the user level components 210-244 and the kernel level components 250-254 are stored by the circuitry of a memory, and these instructions are executed by the hardware, such as the circuitry, of a general-purpose processor (not shown). The data of the ring buffer 260 are also stored by circuitry of the memory. A region of the memory is allocated for the ring buffer 260 by the kernel mode driver 252. Access of this data stored in the ring buffer 260 is managed by the kernel mode driver 252. Therefore, using the kernel mode driver 252, this data is accessed by the general-purpose processor (not shown) and the memory controller 270 of the processor 290.

In this model, each one of the components 210-254 is responsible for processing a part of a function or request. The components are connected in a particular order, such as a chain of calls, beginning with an application (not shown, but a copy is included in each of the instances 240, 242 and 244) to the memory manager driver 254 prior to reaching the hardware level. If the function or request cannot be completed, information for a lower component in the stack or chain is set up and the request/function is passed along to that component. Such a layered driver model allows functionality to be dynamically added to a stack or chain. It also allows each component to specialize in a particular type of function and decouples it from having to know about other components.

In various implementations, a requested parallel data application targeted by a user request is a computer program written by one or more developers in one of a variety of high-level programming languages such as such as C, C++, FORTRAN, and Java and so on. The developers use a parallel computing platform and corresponding application programming interface (API) models for developing the application to include instructions for directing a SIMD core to perform parallel data operations. An example of a parallel data operation is a General Matrix to Matrix Multiplication (GEMM) operation that multiplies two input matrices together to generate a third output matrix. For example, the application includes algorithms for a graphics shader program that directs how a SIMD processor core renders pixels for controlling lighting and shading effects. In addition, the application includes pixel interpolation algorithms for geometric transformations. Pixel interpolation obtains new pixel values at arbitrary coordinates from existing data. In some implementations, the requested application is a particular video game application that is accessed through the Internet. Another example of the application are algorithms used for the training of deep neural networks (DNNs) and other types of neural networks. Yet other applications include instructions for directing a SIMD core to perform GEMM operations or other parallel data operations for other scientific and business uses.

The developers use a parallel computing platform and corresponding application programming interface (API) models for developing the requested application. An example of the parallel computing platform is the OpenCL® (Open Computing Language) framework. The OpenCL framework (generally referred to herein as “OpenCL”) includes a C-like language. For video graphics applications, one example of the language is the GLSL (OpenGL Shading Language). A function call in the C-like language is referred to as an OpenCL kernel, a software kernel, a compute kernel, or simply a “kernel”. Further, DirectX is a platform for running programs on GPUs in systems using one of a variety of Microsoft operating systems. For video graphics applications and other parallel data computing applications, another example of the parallel computing platform is the Vulkan® framework. The Vulkan framework provides lower-level (closer to the hardware control) application programming interface (API) for the developed application. The developers gain more control over the distribution of tasks among multiple parallel data processor cores (SIMD cores). In addition, the Vulkan framework reduces the workload for general-purpose processing units through the use of batching and other low-level optimizations.

The general-purpose processor creates each of the multiple instances 240, 242, and 244 when users request to execute the particular parallel data application. When creating each of the multiple instances 240, 242, and 244, the general-purpose processor relies on information such as at least identification of the application, identification of a version of the application, and identification of targeted hardware to run the application such as the parallel data processor. Other information of the created instance is similar to an operating system process state information. Therefore, each of the multiple instances 240, 242, and 244 has its own resources separate from any other instance of the multiple instances 240, 242, and 244 running on the same hardware such as the parallel data processor. Each of the multiple instances 240, 242, and 244 includes multiple framework layers (also referred to as drivers) with one of these layers capable of translating instructions of a parallel data function call in the application to commands particular to a piece of hardware such as the parallel data processor.

Each of the multiple instances 240, 242, and 244 is also capable of sending the translated commands to the kernel mode driver 252 via the I/O manager driver 250. In various implementations, the kernel mode driver 252 redirects I/O requests to the driver managing the target device such as the memory manager driver 254 for a memory. In some implementations, one or more of the I/O manager 250 and a layer within the instances 240, 242, and 244 ensures only one of the instances 240, 242, and 244 sends translated commands to the hardware of the parallel data processor at a time by using locking primitives. The memory manager driver 254 provides a means for the instances 240, 242, and 244 to send information, such as the translated commands, to storage media such as the ring buffer 260 on memory accessible by each of the general-purpose processor and the parallel data processor. When executing the instructions of one or more of the kernel mode driver 252 and the memory manager driver 254, the general-purpose processor also allocates memory as directed by indications from the instances 240, 242, and 244. In an implementation, the kernel mode driver 252 also assigns state information for a command group. Examples of the state information are a process identifier (ID), a protected/unprotected mode, a compute/graphics type of work, and so on.

The memory controller 270 in the hardware level accesses the translated commands and the state information stored in the ring buffer 260. The command processor 280 uses interfaces to the memory controller 270 for accessing the commands stored on the ring buffer 260. The command processor 280 also uses interfaces to compute resources on the parallel data processor. The command processor 280 schedules the retrieved the commands on the parallel data processor based on the state information.

To avoid allocating too much memory for each of the instances 240, 242, and 244 when executing the instructions of one or more of the kernel mode driver 252 and the memory manager driver 254, the general-purpose processor performs particular steps. These steps include the general-purpose processor sending a search query to the agent 210 via the API 220 while executing instructions of a sharing layer (not shown) within the instances 240, 242, and 244. When executing the instructions of the sharing layer in the instance 240, in an implementation, the general-purpose processor detects a function call of the application, and sends the search query that identifies a particular data object to be used by the function call. The agent 210 searches the mappings 212 based on the identification information associated with the data object.

When executing the instructions of one or more of the kernel mode driver 252 and the memory manager driver 254, the general-purpose processor frees data storage allocated to the data object when the search result indicates that the data object is already shared by one or more of the instances 242 and 244. Therefore, the instance 240 sends an indication along with translated commands to the I/O manager 250 indicating that no data storage is needed to be allocated for the data object. Rather, a pointer from the mappings 212 is sent instead that identifies a memory location storing a copy of the data object, which is a shareable data object among the instances 240, 242 and 244. Accordingly, an amount of memory allocated for the multiple instances 240, 242, and 244 of the application is reduced and system performance increases. For example, if the instances 230 includes 100 individual instances for a same application to be executed on the same parallel data processor, only a single copy of a shareable data object is stored for the 100 instances, rather than 100 individual copies of the shareable data object being stored. In implementations where the application is a graphics application, the amount of data storage in the memory used for frame buffers is reduced.

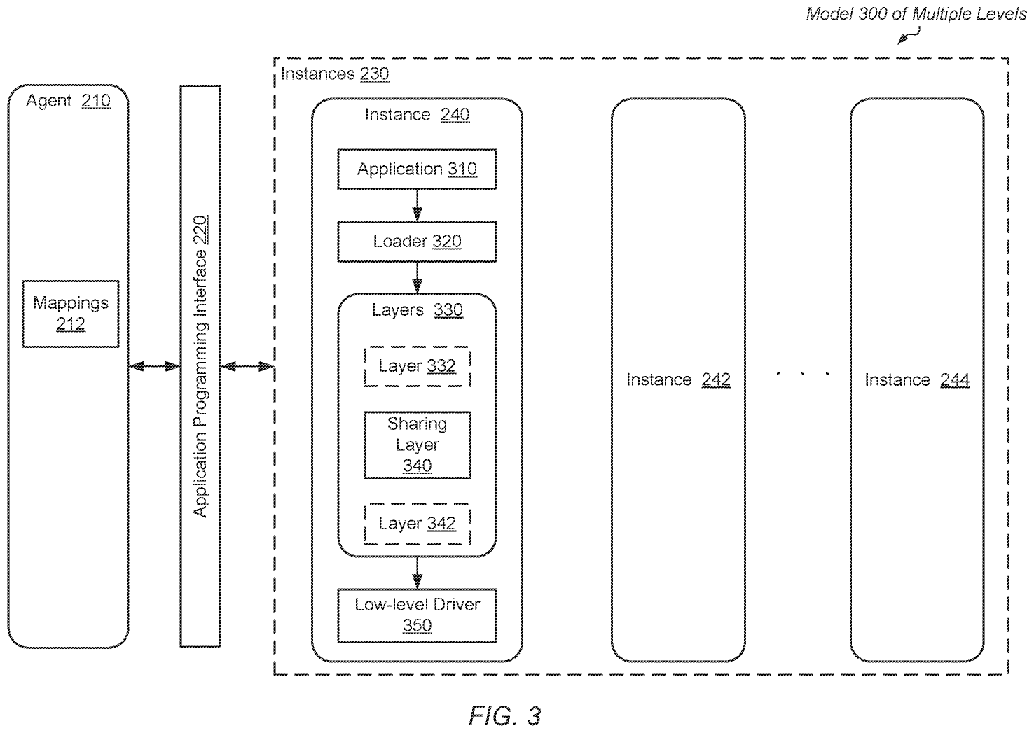

Referring to FIG. 3, a generalized diagram is shown of a model 300 of multiple levels of a computing system. Similar system components as described earlier are numbered identically. The kernel level and hardware level are not shown for ease of illustration. As shown, the instance 240 of the user level includes multiple components such as the application 310, the framework loader 320 (or loader 320), the framework layers 330 (or layers 330), and the low-level driver 350. The parallel computing framework library defines a parallel data application programming interface (API) model. In various implementations, the Vulkan framework is used, but in other implementations, another parallel computing framework (or framework) is used. Each of the instances 242 and 244 include similar components as the instance 240.

When executing the instructions of the framework loader 320, a corresponding processor core, such as a general-purpose processor core, discovers which low-level drivers for hardware are available in the computing system. The processor core enumerates the available hardware, such as hardware devices (cores or processing units) and returns this information to the application 310. For the available hardware selected to run the application 310, such as a particular SIMD core or an entire parallel data processing unit, the processor core initializes variables used by the instructions of a corresponding low-level driver 350. In an implementation, the low-level driver is a graphics driver. In the Vulkan framework, this low-level driver is referred to as an “installable client driver,” or an ICD.

When executing the instructions of the framework loader 320, the processor core injects one or more framework layers 330 into the instance 240 with each of the framework layers 330 providing particular functionality. For example, the processor core injects at least a sharing framework layer 340 into the instance 240 as one of the one or more framework layers 330. The processor core can also inject (or insert or add), in the instance 240, the framework layers 332 and 342 in a particular order relative to one another and relative to the sharing framework layer 340. The processor core selects the one or more framework layers 330 based on hints from the developer, indications from the application, standard system settings, or other. When executing the instructions of the framework loader 320, the processor core assigns framework functions of the application 310 to appropriate layers of the framework layers 330 and the low-level driver 350. It is noted that when executing the instructions of the framework loader 320, the processor core injects (or inserts) the framework layers 330 into the instance 240 in a particular order, such as a chain of calls, such that the processor core later executes the framework layers 330 based on this order prior to calling the low-level driver 350.

When executing instructions of the sharing layer 340 (or framework sharing layer 340), the processor core detects a graphics function call or other parallel data function call in the application 310. Based on the instructions of the sharing layer 340, the processor core determines whether a size of a requested data object of the function call is greater than a size threshold. If so, based on instructions of the sharing layer 340, the processor core determines whether the requested data object is non-writeable. If so, then based on the instructions of the sharing layer 340, the processor core generates an index for the requested data object. In an implementation, the index is an output of a hash function that uses a file descriptor of the requested data object as an input. The processor core sends the index to the agent 210 via the API 220. In an implementation, the API 220 is an operating system domain socket.

Based on the instructions of the agent 210, the processor core searches the mappings 212 using the index. If a match is found, the agent 210 returns a corresponding mapping to the sharing layer 340. This mapping includes the index and a pointer to a location in memory storing the requested data object for one of the instances 242 and 244 different from the instance 240. The low-level driver 350 uses this pointer and an indication that specifies no allocation of memory for the instance 240 for the requested data object. Therefore, the corresponding hardware, such as the processor core capable of creating instances, does not allocate memory for this data object for instance 240.

If a match was not found during the search of the mappings 212, then the agent 210 returns an indication of the miss to the sharing layer 340. In response, the sharing layer 340 sends, to the agent 210, a mapping between the index and a pointer to a location in memory to store the requested data object for the instance 240. The agent 210 stores this mapping in the mappings 212. The low-level driver 350 uses this pointer and an indication that specifies allocation of memory for the instance 240 for the requested data object. Therefore, memory for this data object is allocated for instance 240. For example, in an implementation, when executing the instructions of one or more of the kernel mode driver 252 and memory manager driver 254, the general-purpose processor allocates memory for this data object for instance 240.

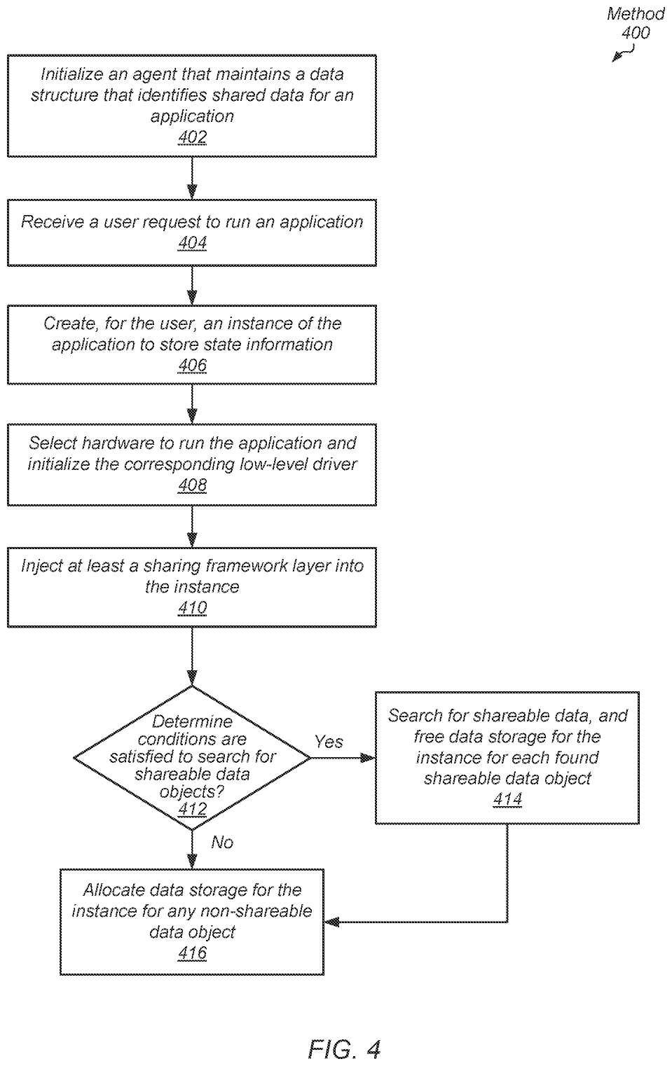

The upcoming descriptions of the methods 400-600 (of FIGS. 4-6) provide details of steps to perform to efficiently execute multiple processes by reducing an amount of memory usage of the processes. The description of the methods 400-600 utilize a similar computing system that is described here. In various implementations, a processor core that initializes an agent is a general-purpose processor core of a general-purpose processing unit. For example, the general-purpose processing unit is a central processing unit (CPU), with multiple cores capable of executing instructions of a general-purpose instruction set architecture (ISA). In some implementations, the processor core is used within a remote server computer (or remote server) that provides cloud computing services to multiple users. The processor core executes instructions of a copy of an operating system and one or more applications stored in system memory and/or caches of a cache memory subsystem of the remote server. The processor core also executes instructions of the agent that maintains the data structure. The data structure stores identification information of particular shared data that is used by multiple hardware devices of the remote server. In an implementation, the granularity of the hardware device is a parallel data processing unit of multiple parallel data processing units of the remote server. The data structure is a data storage area that is implemented with one of a variety of data storage circuits such as a particular region of system memory, flip-flop circuits, a random-access memory (RAM), a content addressable memory (CAM), a set of registers, a first-in-first-out (FIFO) buffer, or other.

In various implementations, the remote server also includes at least one parallel data processing unit that includes the circuitry of one or more processor cores with a single instruction multiple data (SIMD) parallel architecture. In an implementation, the general-purpose processing unit and the parallel data processing unit are placed in a same package, such as a system on a chip (SoC), on the motherboard. In another implementation, the general-purpose processing unit is located on the motherboard, whereas the parallel data processing unit is located on a card that is inserted in a slot on the motherboard. In yet another implementation, the motherboard of the server includes the parallel data processing unit in addition to the general-purpose processing unit. It is also possible and contemplated that the server includes multiple cards, each with a parallel data processing unit, inserted in multiple slots (or sockets) on the motherboard.

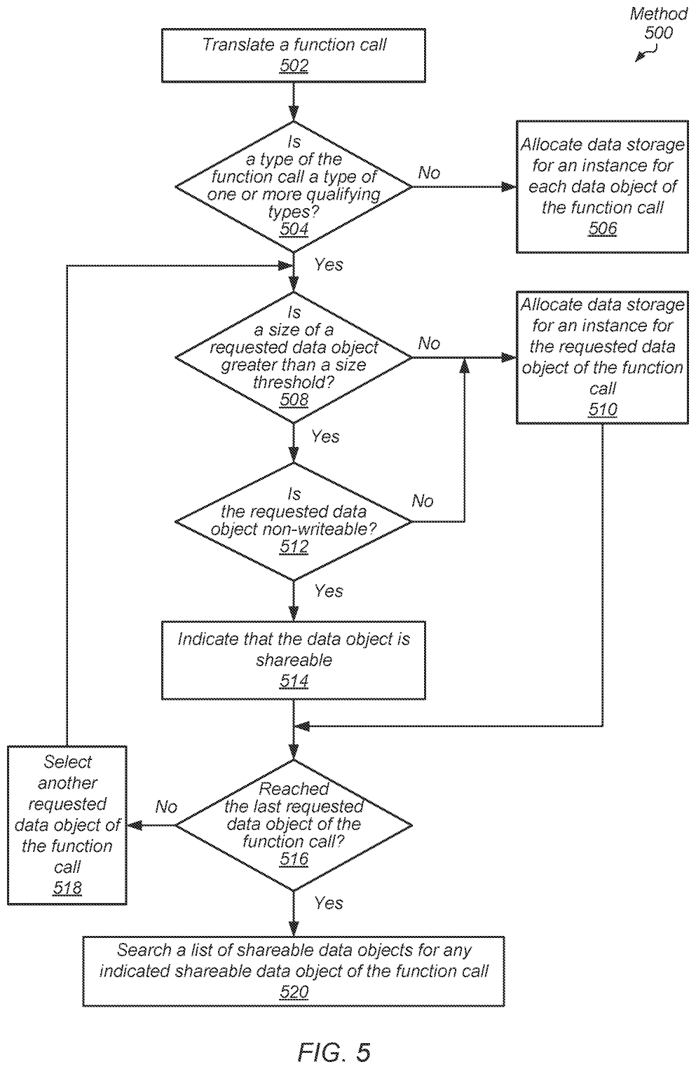

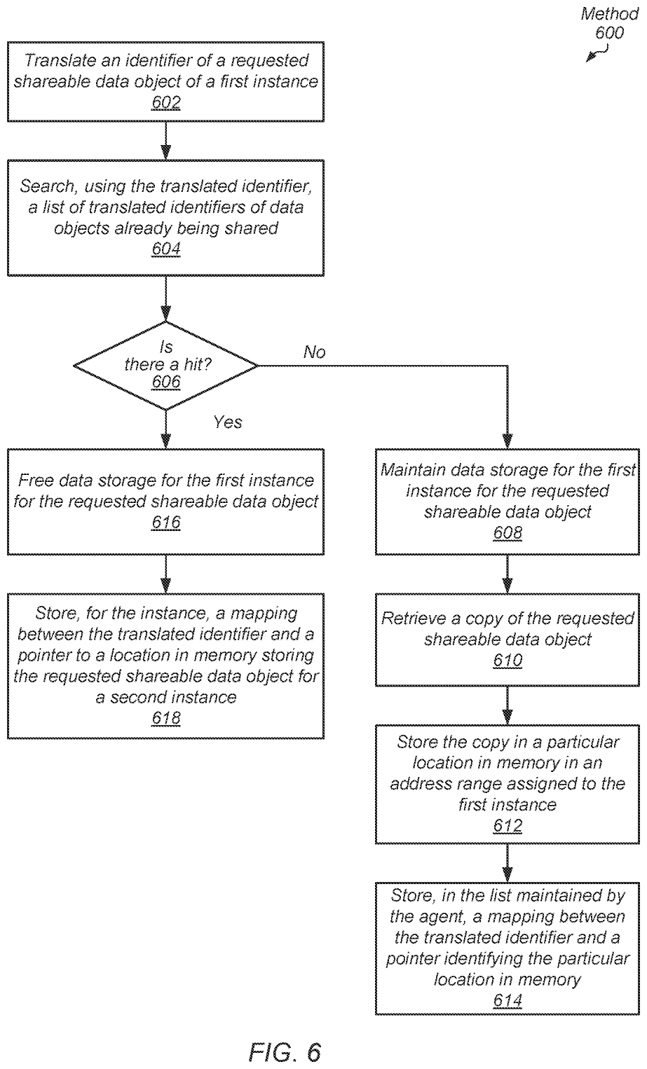

In various implementations, a remote server stores an application that is requested by users over a network such as the Internet. As described earlier, the requested application is written by developers using a parallel computing platform and corresponding application programming interface (API) models for developing the application to include instructions for directing a SIMD core to perform parallel data operations. Referring now to FIG. 4, a generalized block diagram is shown of a method 400 for efficient execution of multiple processes by reducing an amount of memory usage of the processes. For purposes of discussion, the steps in this implementation (as well as in FIGS. 5-6) are shown in sequential order. However, in other implementations some steps occur in a different order than shown, some steps are performed concurrently, some steps are combined with other steps, and some steps are absent.

The hardware, such as circuitry, of a processor core initializes an agent that maintains a data structure for an application (block 402). In various implementations, the processor core is included in the remote server. The processor core receives a user request to run an application (block 404). Therefore, a user computing device received user input to begin using the application, and the user computing device sent the user request across a network, such as the Internet, to the processor of the remote server. The circuitry of the general-purpose processing unit begins processing the requested application. To do so, the general-purpose processing unit begins executing instructions of user mode components of a layered driver model. One example is the Vulkan API model. The general-purpose processing unit executes the layered driver model of the Vulkan framework (parallel data API model). In some implementations, the circuitry of a general-purpose processor core (or processor core) of the general-purpose processing unit creates, for the user, an instance of the application to store state information (block 406). The Vulkan framework does not rely on global state information, so state information for the application is stored in a particular region of memory such as a particular data structure.

When creating the instance, the processor core relies on information such as at least identification of the application, identification of a version of the application, and identification of targeted hardware to run the application. Creating the instance links the application to the framework library (Vulkan library). Other information of the created instance is similar to an operating system process state information. Therefore, the instance of the application has its own resources separate from any other instance of the same application. The resources include at least an image of memory that stores instructions and data before application execution. This image of memory is within a particular address space. However, as described shortly, the amount of data and the amount of memory used is adjusted, such as reduced or limited, based on detecting shared data for a hardware device. In an implementation, the granularity of the hardware device is a parallel data processing unit of multiple parallel data processing units of the remote server.

When executing the instructions of the framework loader, the processor core discovers which low-level drivers for hardware are available in the computing system. The processor core enumerates the available hardware, such as hardware devices (cores or processing units) and returns this information to the application. For the available hardware selected to run the application, such as a particular SIMD core or an entire parallel data processing unit, the processor core initializes variables used by the instructions of a corresponding low-level driver (block 408). In an implementation, the low-level driver is a graphics driver. In the Vulkan framework, this low-level driver is referred to as an “installable client driver,” or an ICD.

When executing the instructions of the framework loader, the processor core injects one or more framework layers into the instance with each of the framework layers providing particular functionality. The processor core injects at least a sharing framework layer into the instance as one of the one or more framework layers (block 410). The processor core selects the one or more framework layers based on hints from the developer, indications from the application, standard system settings, or other. When executing the instructions of the framework loader, the processor core assigns framework functions of the application to appropriate framework layers and low-level drivers. It is noted that when executing the instructions of the framework loader, the processor core injects (or inserts) the framework layers into the instance in a particular order, such as a chain of calls, such that the processor core later executes the framework layers based on this order prior to calling the low-level driver.

The processor core translates function calls within the application to commands by a particular application programming interface (API) such as the framework API (Vulkan API). In an implementation, the processor core will later place commands in a command group and store them in a ring buffer for a particular parallel data processing unit to retrieve. Next, the processor core determines whether conditions are satisfied to search for shareable data. Further details of these conditions are provided in the description of method 500 (of FIG. 5).

If the processor core determines conditions are satisfied to search for shareable data (“yes” branch of the conditional block 412), then when executing further instructions of the sharing layer, the processor core searches for shareable data, and frees data storage for the instance for each found shareable data object (block 414). Therefore, an amount of memory allocated for the multiple instances of the application being executed by the particular parallel data processing unit is reduced. This data storage reduction in the memory improves system performance. However, if the processor core determines conditions are not satisfied to search for shareable data (“no” branch of the conditional block 412), then when executing further instructions of the sharing layer, the processor core allocates data storage for the instance for any non-shareable data object (block 416). Similarly, for any data object not found to be shareable during the search, the processor core allocates data storage for corresponding data objects.

Turning now to FIG. 5, a generalized block diagram is shown of a method 500 for determining conditions are satisfied to search for shareable data used by multiple instances of a particular application. As described earlier, a remote server of a computing system includes a first processor, such as a general-purpose processor, and a second processor that supports a single instruction multiple data (SIMD) parallel architecture. In an implementation, an accelerated processing unit (APU) on a motherboard includes the first processor and the second processor. The first processor translates instructions of parallel data function calls of the application to commands that are executable by the second processor (block 502).

The first processor determines whether a detected function call has a type that matches one or more qualifying types. Examples of the one or more qualifying types are a graphics function call and other function calls supporting parallel data algorithms used for neural network training, cryptography, scientific or business uses, and so forth. If the first processor determines the type of the function call is not one of the one or more qualifying types (“no” branch of the conditional block 504), then the first processor allocates data storage for an instance for each data object of the function call (block 506). The first processor determines these data objects are non-shareable. Method 500 completes for this function call.

However, if the first processor determines the type of the function call is one of the one or more qualifying types (“yes” branch of the conditional block 504), and the first processor determines a size of a requested data object of the function call is less than or equal to a size threshold (“no” branch of the conditional block 508), then the first processor allocates data storage for an instance for the requested data object of the function call (block 510). The second processor executes the instance of the application using the translated commands. The first processor determines this requested data object is non-shareable, but other data objects of the function call are yet to be determined regarding being shareable or non-shareable. Control flow of method 500 moves to conditional block 516, which is further described in the below description.

If the first processor determines a size of a requested data object of the function call is greater than the size threshold (“yes” branch of the conditional block 508), but the first processor determines the requested data object is writeable (“no” branch of the conditional block 512), then the first processor moves to block 510 where the first processor allocates data storage for an instance for the requested data object of the function call. If the first processor determines a size of a requested data object of the function call is greater than the size threshold (“yes” branch of the conditional block 508), and the first processor determines the requested data object is non-writeable (“yes” branch of the conditional block 512), then the first processor indicates that the data object is shareable (block 514). In an implementation, the first processor stores an asserted flag, bit or other indicator that specifies that the requested data object is shareable.

If the first processor did not yet reach the last requested data object of the function call (“no” branch of the conditional block 516), then the first processor selects another requested data object of the function call (block 518). Afterward, control flow of method 500 returns to conditional block 508 where the first processor determines whether the size of the requested data object is greater than the size threshold. However, if the first processor has reached the last requested data object of the function call (“yes” branch of the conditional block 516), then the first processor searches a list of shareable data objects for any indicated shareable data object of the function call (block 520). Further details of the search operation are provided in the description of method 600 (of FIG. 6).

Referring to FIG. 6, a generalized block diagram is shown of a method 600 for searching for shareable data used by multiple instances of a particular application. As described earlier, a first processor of the computing system translates an identifier of a requested shareable data object of a first instance (block 602).

In an example, the first processor translates a first identifier of a first type of the requested shareable data object to a second identifier of a second type. In some implementations, the first identifier is a file descriptor of the memory region assigned to store the requested shareable data object. When executing instructions of the kernel of the operating system, the first processor updates one or more file tables each time an instance is created. The instance is capable of accessing resources through system calls to the kernel using file descriptors. The instances do not directly access system resources. The first identifier is used as a unique identifier for this memory region. In an implementation, the first processor generates the second identifier by performing a hash function using at least the first identifier as an input. In other implementations, the first processor performs other operations, such as one of a variety of encryption algorithms, to generate the second identifier using at least the first identifier as an input.

The first processor searches, using the translated identifier, a list of translated identifiers of data objects already being shared (block 604). In some implementations, the list is implemented as a table or other data structure that is a data storage area implemented with one of a variety of data storage circuits such as a particular region of system memory, flip-flop circuits, a random-access memory (RAM), a content addressable memory (CAM), a set of registers, a first-in-first-out (FIFO) buffer, or other.

If the search results in a miss in the list (or table or data structure) (“no” branch of the conditional block 606), then the first processor maintains data storage for the first instance for the requested shareable data object (block 608). In an implementation, the first processor inserts commands in a command group for the second processor to execute, and some of these commands direct the second processor to retrieve a copy of the requested shareable data object (block 610). In an implementation, the second processor retrieves the copy of the requested shareable data object from local memory. Examples of local memory are a local data store or a local buffer. In some implementations, the functionality of the local memory is provided by memory such as the memory 128 (of FIG. 1). Following, when executing commands from the first processor, the second processor stores the copy in a particular location in memory in an address range assigned to the first instance (block 612). The first processor stores, in the list (or table or data structure), a mapping between the translated identifier (second identifier) and a pointer identifying the particular location in memory (block 614). In an implementation, the first processor executes instructions of an agent that maintains the list and performs the searches of the list.

If the search results in a hit in the list (or table or data structure) (“yes” branch of the conditional block 606), then the first processor frees data storage for the first instance for the requested shareable data object (block 616). As described earlier, in some implementations, the first processor inserts commands in a command group for the second processor to execute, and some of these commands make the data storage in local memory of the second processor to be available for other data besides the requested shareable data object. Alternatively, the commands make this data storage available for other instances other than first instance. The first processor stores, for the first instance, a mapping between the translated identifier (second identifier) and a pointer to a location in memory storing the requested shareable data object for a second instance different from the first instance (block 618). Therefore, an amount of memory allocated for the first instance is reduced, which reduces the amount of memory allocated for the multiple instances of the application being executed by the second processor. This data storage reduction in the memory improves system performance.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
create a plurality of instances of an application to be executed by a processor;
detect a function call of the application within a first instance of the plurality of instances; and
search for shareable data objects to be used by the processor when executing the function call of the first instance.

2. The apparatus as recited in claim 1, wherein the circuitry is further configured to search for shareable data objects to be used by the processor when executing the first instance of the function call, in further response to determining one or more of:
a data object used by the function call is a non-writeable data object; and
a size of the data object used by the function call is greater than a size threshold.

3. The apparatus as recited in claim 1, wherein the circuitry is further configured to free data storage allocated for the first instance to be used for storing a first data object, in response to determining the first data object is already shared by one or more instances of the plurality of instances of the application being executed by the processor.

4. The apparatus as recited in claim 3, wherein the circuitry is further configured to:
translate a first identifier of a first type of the first data object to a second identifier of a second type; and
search, using the second identifier, a table storing one or more mappings between identifiers of the second type and pointers identifying memory locations that store data objects in address ranges of the plurality of instances of the application.

5. The apparatus as recited in claim 4, wherein the circuitry is further configured to generate the second identifier by performing a hash function using at least the first identifier.

6. The apparatus as recited in claim 4, wherein the circuitry is further configured to maintain data storage allocated for the first instance to be used for storing a second data object, in response to determining the second data object is not already shared by one or more instances of the plurality of instances of the application being executed by the processor.

7. The apparatus as recited in claim 6, wherein the circuitry is further configured to:
store a copy of the second data object in a particular memory location of data storage allocated for the first instance; and
store, in the table, a mapping between an identifier of the second type of the second data object and the particular memory location.

8. A method, comprising:
creating, by a first processor, a plurality of instances of an application to be executed by a second processor;
detecting, by the first processor, a function call of the application within a first instance of the plurality of instances; and
searching, by the first processor, for shareable data objects to be used by the second processor when executing the function call of the first instance.

9. The method as recited in claim 8, further comprising searching, by the first processor, for shareable data objects to be used by the second processor when executing the first instance of the function call, in further response to determining one or more of:
a data object used by the function call is a non-writeable data object; and
a size of the data object used by the function call is greater than a size threshold.

10. The method as recited in claim 8, further comprising freeing, by the first processor, data storage allocated for the first instance to be used for storing a first data object, in response to determining the first data object is already shared by one or more instances of the plurality of instances of the application being executed by the second processor.

11. The method as recited in claim 10, further comprising:
translating, by the first processor, a first identifier of a first type of the first data object to a second identifier of a second type; and
searching, by the first processor using the second identifier, a table storing one or more mappings between identifiers of the second type and pointers identifying memory locations that store data objects in address ranges of the plurality of instances of the application.

12. The method as recited in claim 11, further comprising generating, by the first processor, the second identifier by performing a hash function using at least the first identifier.

13. The method as recited in claim 11, further comprising maintaining, by the first processor, data storage allocated for the first instance to be used for storing a second data object, in response to determining the second data object is not already shared by one or more instances of the plurality of instances of the application being executed by the second processor.

14. The method as recited in claim 13, further comprising:
storing, by the first processor, a copy of the second data object in a particular memory location of data storage allocated for the first instance; and
storing, by the first processor in the table, a mapping between an identifier of the second type of the second data object and the particular memory location.

15. A computing system comprising:
a first processor; and
a second processor; and
wherein the first processor is configured to:
create a plurality of instances of an application to be executed by the second processor;
detect a function call of the application within a first instance of the plurality of instances; and
search for shareable data objects to be used by the second processor when executing the function call of the first instance.

16. The computing system as recited in claim 15, wherein the first processor is further configured to search for shareable data objects to be used by the second processor when executing the first instance of the function call, in further response to determining one or more of:
a data object used by the function call is a non-writeable data object; and
a size of the data object used by the function call is greater than a size threshold.

17. The computing system as recited in claim 15, wherein the first processor is further configured to free data storage allocated for the first instance to be used for storing a first data object, in response to determining the first data object is already shared by one or more instances of the plurality of instances of the application being executed by the second processor.

18. The computing system as recited in claim 17, wherein the first processor is further configured to:
translate a first identifier of a first type of the first data object to a second identifier of a second type; and
search, using the second identifier, a table storing one or more mappings between identifiers of the second type and pointers identifying memory locations that store data objects in address ranges of the plurality of instances of the application.

19. The computing system as recited in claim 18, wherein the first processor is further configured to maintain data storage allocated for the first instance to be used for storing a second data object, in response to determining the second data object is not already shared by one or more instances of the plurality of instances of the application being executed by the second processor.

20. The computing system as recited in claim 19, wherein the first processor is further configured to:
store a copy of the second data object in a particular memory location of data storage allocated for the first instance; and
store, in the table, a mapping between an identifier of the second type of the second data object and the particular memory location.
